(19) United States
(12) Patent Application Publication
(10) Pub. No.: US 2026/0121551 A1
(43) Pub. Date: Apr. 30, 2026

(54) POWER CONVERSION DEVICE AND REFRIGERATION CYCLE APPARATUS

(71) Applicant: MITSUBISHI ELECTRIC CORPORATION, Tokyo (JP)

(72) Inventors: Shuta ISHIKAWA, Tokyo (JP); Toshiki ASAI, Tokyo (JP)

(73) Assignee: MITSUBISHI ELECTRIC CORPORATION, Tokyo (JP)

(21) Appl. No.: 19/310,986

(22) Filed: Aug. 27, 2025

(30) Foreign Application Priority Data
Oct. 31, 2024 (JP) 2024-191463

(51) Int. Cl. H02M 7/217; H02M 1/44

(52) U.S. Cl. CPC H02M 7/217; H02M 1/44; F25B 2600/021

(57) ABSTRACT

An object of the present disclosure is to reduce a carrier ripple current and to reduce an outflow of a carrier ripple current to a power supply. The power conversion device includes a rectifier circuit to convert an input voltage (interphase voltage) of a three-phase AC input from AC input terminals into a DC voltage, a converter to output an output voltage set to a set voltage value from the DC voltage output from the rectifier circuit, a smoothing capacitor connected between a positive-side converter output terminal (DC output terminal) and a negative-side converter output terminal (DC output terminal) of the converter from which the output voltage is output, an LC filter disposed between the AC input terminals, and the converter and including a filter reactor and a filter capacitor, and a controller to control the converter.

### CROSS-REFERENCE TO RELATED APPLICATION

The present application claims the benefit of priority to Japanese Patent Application No. 2024-191463, filed Oct. 31, 2024, which is incorporated herein by reference in its entirety.

### BACKGROUND OF THE INVENTION

### 1. Field of the Invention

The present disclosure relates to a power conversion device and a refrigeration cycle apparatus.

### 2. Description of the Background Art

Patent Document 1 discloses a step-down chopper device that receives a three-phase AC as an input, converts the input current into a DC voltage via a rectifier, and steps down the converted voltage by switching a semiconductor switch. The step-down chopper device includes a smoothing capacitor on the output side, and a current on which a carrier ripple current is superimposed is generated due to the influence of the switching of the semiconductor switch. Therefore, if the carrier ripple current is allowed to flow out as it is, there is a possibility that peripheral devices are to be broken.

In view of this, the step-down chopper device of Patent Document 1 is provided with a capacitor (filter capacitor) for removing the carrier ripple current between a step-down converter and the rectifier. The step-down converter being configured by a semiconductor switch, a diode, and a reactor. The carrier ripple current generated in the step-down converter is absorbed by the capacitor disposed on the input side of the step-down converter, thereby reducing the carrier ripple current flowing out to the peripheral devices of the step-down chopper device.

Furthermore, the step-down chopper device of Patent Document 1 compares a modulated triangular wave S4 generated on the basis of a voltage Vi of the filter capacitor with an output signal S1 based on an output voltage Vo of the smoothing capacitor, thereby generating a pulse width modulation (PWM) signal S5 based on the comparison result to control the semiconductor switch. That is, the step-down chopper device of Patent Document 1 performs feedback control of the output voltage Vo on the basis of the output voltage Vo being the voltage of the smoothing capacitor, and the voltage Vi of the filter capacitor. In addition, by reducing the ripple of the output voltage Vo, the step-down chopper device of Patent Document 1 can reduce the electrostatic capacitance of the filter capacitor on the input side of the step-down converter.
Patent Document 1: Japanese Patent Application Laid-Open No. 2000-312478
Patent Document 2: International Publication No. WO2023/073870

Patent Document 2 discloses that if the electrostatic capacitance of a filter capacitor, which is a capacitor disposed between a rectifier and a power conversion unit that converts DC power into AC power, is made too large, an input current to the filter capacitor and a charging/discharging current of the filter capacitor have a shape resembling “rabbit ears”, that is, a spike shape. This spike shaped current flows out of the rectifier to the power supply, causing the power supply current to have a spike shape. That is, the power supply current is greatly distorted, and the power supply harmonics are deteriorated.

### SUMMARY OF THE INVENTION

The present disclosure aims to reduce a carrier ripple current and to reduce an outflow of the carrier ripple current to a power supply.

A power conversion device according to the present disclosure includes a rectifier circuit to convert an input voltage of a three-phase AC input from AC input terminals into a DC voltage, a converter to output an output voltage set to a set voltage value from the DC voltage output from the rectifier circuit, a smoothing capacitor connected between a positive-side converter output terminal and a negative-side converter output terminal of the converter from which the output voltage is output, an LC filter disposed between the AC input terminals and the converter and including a filter reactor and a filter capacitor, a controller to control the converter. The filter reactor is disposed closer to the AC input terminals than the filter capacitor.

In the power conversion device of the present disclosure, the LC filter including the filter reactor and the filter capacitor is disposed between the AC input terminals and the converter, and the filter reactor is disposed closer to the AC input terminals than the filter capacitor. Therefore, it is possible to reduce the carrier ripple current and to reduce an outflow of the carrier ripple current to the power supply.

### BRIEF DESCRIPTION OF THE DRAWINGS

FIG. 1 is a diagram showing a configuration of a power conversion device according to Embodiment 1.

FIG. 2 is a diagram showing a configuration of a controller according to Embodiment 1.

FIG. 3 is a diagram for describing a duty ratio.

FIG. 4 is a diagram showing a configuration of a rectifier circuit of FIG. 1.

FIG. 5 is a diagram showing an operation waveform of the power conversion device according to Embodiment 1.

FIG. 6 is a diagram showing an operation waveform of the power conversion device according to Embodiment 1.

FIG. 7 is a diagram showing an operation waveform of the power conversion device according to Embodiment 1.

FIG. 8 is a diagram showing an operation waveform of a power conversion device of Comparative Example 1.

FIG. 9 is a diagram showing an operation waveform of the power conversion device of Comparative Example 1.

FIG. 10 is a diagram showing an operation waveform of the power conversion device of Comparative Example 1.

FIG. 11 is a diagram showing a part of the operation waveform of FIG. 10 in an enlarged manner.

FIG. 12 is a diagram showing an operation waveform of a power conversion device of Comparative Example 2.

FIG. 13 is a diagram showing an operation waveform of the power conversion device of Comparative Example 2.

FIG. 14 is a diagram showing an operation waveform of the power conversion device of Comparative Example 2.

FIG. 15 is a diagram showing an operation waveform of a power conversion device of Comparative Example 3.

FIG. 16 is a diagram showing an operation waveform of the power conversion device of Comparative Example 3.

FIG. 17 is a diagram showing an operation waveform of the power conversion device of Comparative Example 3.

FIG. 18 is a diagram showing a configuration of a power conversion device according to Embodiment 2.

FIG. 19 is a diagram showing a configuration of another example of a converter of FIG. 18.

FIG. 20 is a diagram showing a configuration of a first power conversion device according to Embodiment 3.

FIG. 21 is a diagram showing a configuration of a second power conversion device according to Embodiment 3.

FIG. 22 is a diagram showing a configuration of a power conversion device according to Embodiment 4.

FIG. 23 is a diagram showing a configuration of a controller according to Embodiment 4.

FIG. 24 is a diagram showing a configuration of a refrigeration cycle apparatus according to Embodiment 5.

FIG. 25 is a diagram showing a configuration of a refrigerant circuit of FIG. 24.

FIG. 26 is a diagram showing a configuration of an inverter of FIG. 24.

FIG. 27 is a diagram showing an example of a hardware configuration for implementing a function of a controller by digital computation.

### DETAILED DESCRIPTION OF THE EMBODIMENTS OF THE INVENTION

### Embodiment 1

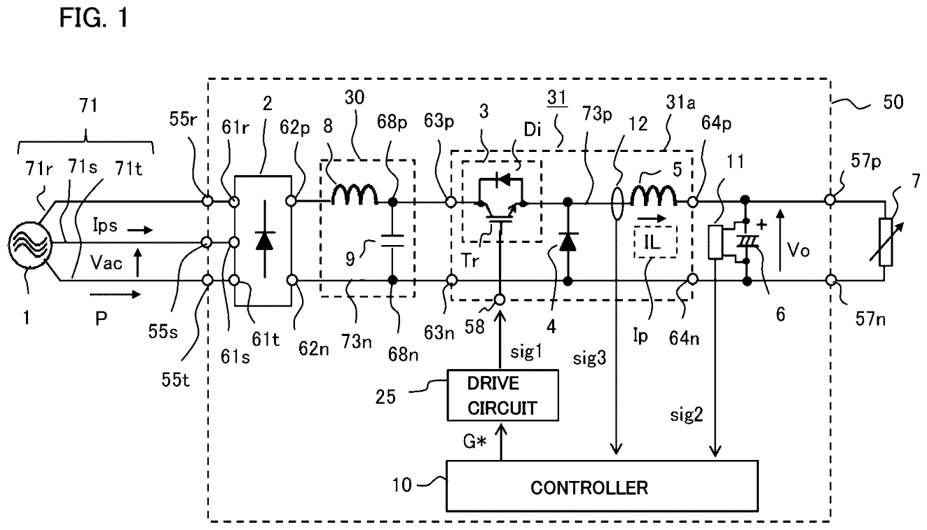

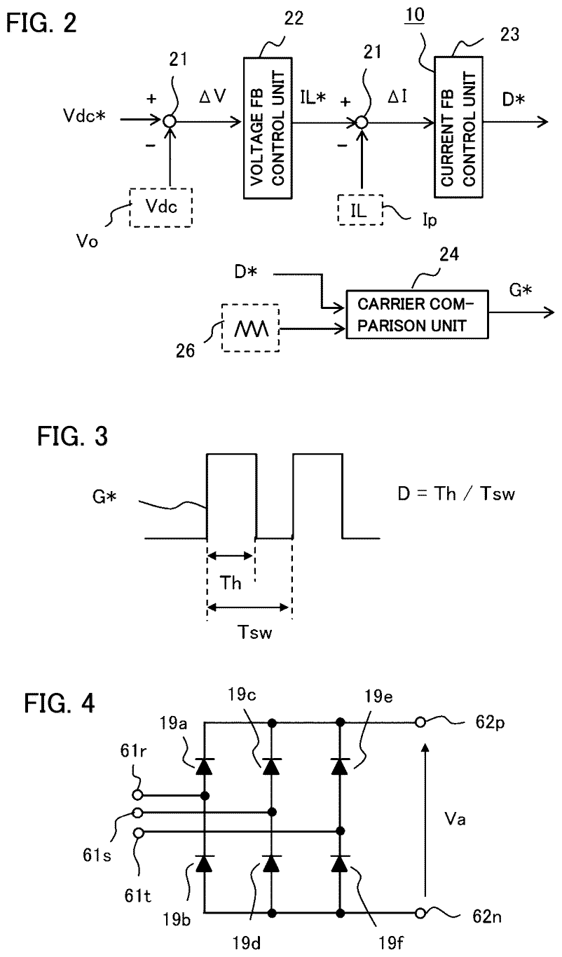

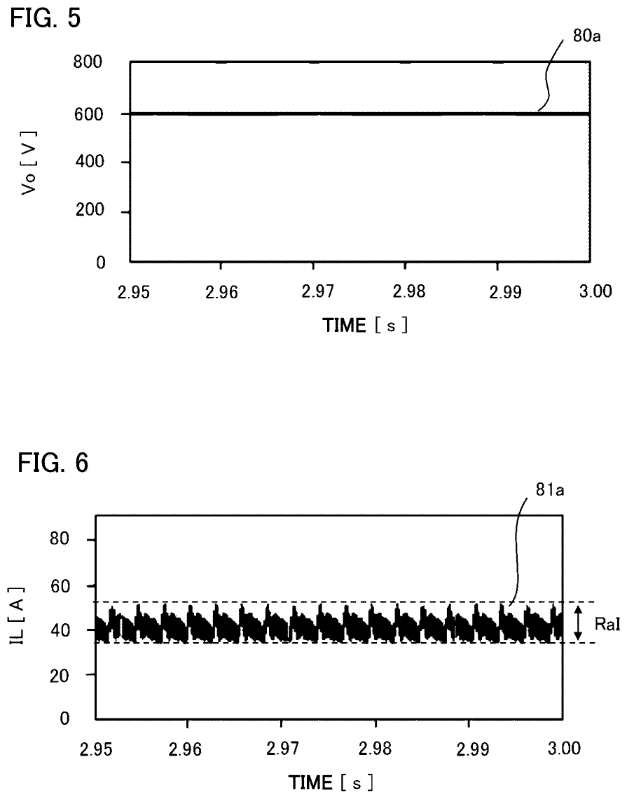

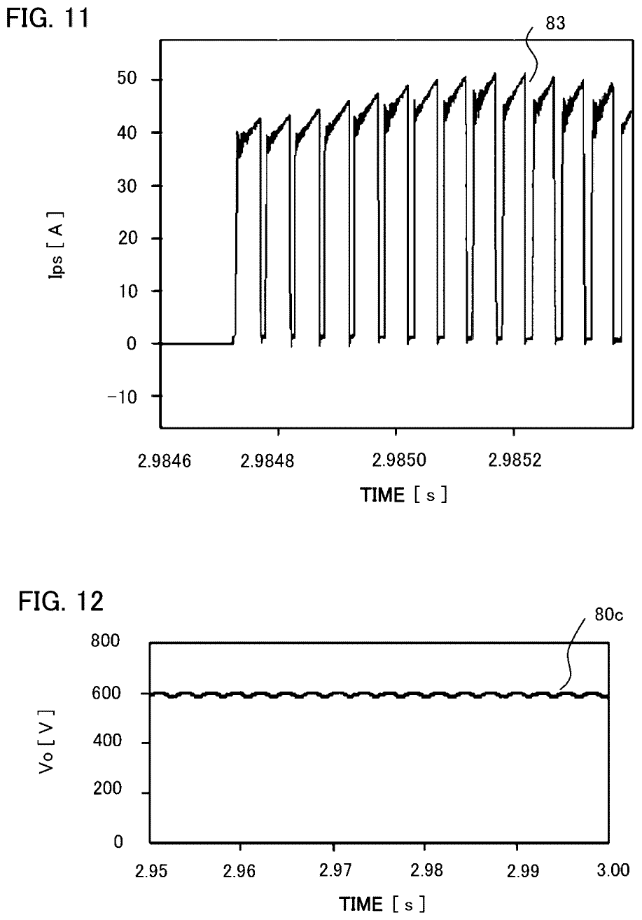

FIG. 1 is a diagram showing a configuration of a power conversion device according to Embodiment 1, and FIG. 2 is a diagram showing a configuration of a controller according to Embodiment 1. FIG. 3 is a diagram for describing a duty ratio, and FIG. 4 is a diagram showing a configuration of a rectifier circuit of FIG. 1. FIG. 5 to FIG. 7 are diagrams showing respective operation waveforms of the power conversion device according to Embodiment 1. FIG. 8 to FIG. 10 are diagrams showing respective operation waveforms of a power conversion device of Comparative Example 1. FIG. 11 is a diagram showing a part of an operation waveform of FIG. 10 in an enlarged manner. FIG. 12 to FIG. 14 are diagrams showing respective operation waveforms of a power conversion device of Comparative Example 2. FIG. 15 to FIG. 17 are diagrams showing respective operation waveforms of a power conversion device of Comparative Example 3. The power conversion device 50 according to Embodiment 1 converts three-phase AC input power input from a three-phase AC power supply 1 into DC power and supplies the DC power to a load 7.

The power conversion device 50 includes a rectifier circuit 2 for converting input power, i.e., an input voltage and an input current, of the three-phase AC power supply 1 from AC input terminals 55r, 55s, and 55t, to DC power i.e., a DC voltage and a DC current, a converter 31 for outputting an output voltage Vo set to a set voltage value, from the DC voltage output from the rectifier circuit 2, a smoothing capacitor 6 connected between a positive-side output terminal 64p (positive-side converter output terminal) and a negative-side output terminal 64n (negative-side converter output terminal) in the converter 31 from which the output voltage Vo is output, and a controller 10 for controlling the converter 31, and supplies to the load 7 DC power having the output voltage Vo set to the set voltage value from output terminals 57p and 57n.

The converter 31 includes a switching element 3, a diode 4, and a control reactor 5. In Embodiment 1, a step-down converter 31a will be described as an example of the converter 31. In Embodiment 2, a step-up converter 31b and a step-up/step-down converter 31c will be described as examples of the converter 31. The smoothing capacitor 6 is connected between the positive-side DC output terminal 64p and the negative-side DC output terminal 64n of the step-down converter 31a, and the smoothing capacitor 6 stabilizes the output voltage Vo. The DC power having the output voltage Vo is supplied to the load 7. As the switching element 3, for example, a power semiconductor element such as an insulated gate bipolar transistor (IGBT), a metal-oxide-semiconductor field-effect transistor (MOSFET), or the like is used. In FIG. 1, an example of an IGBT is shown. The switching element 3 includes a transistor Tr being the IGBT, and a diode Di. The diode Di is connected in anti-parallel to the transistor Tr being the IGBT. When a MOSFET is used as the transistor Tr of the switching element 3, the collector and emitter of the IGBT are interpreted as the drain and source of the MOSFET.

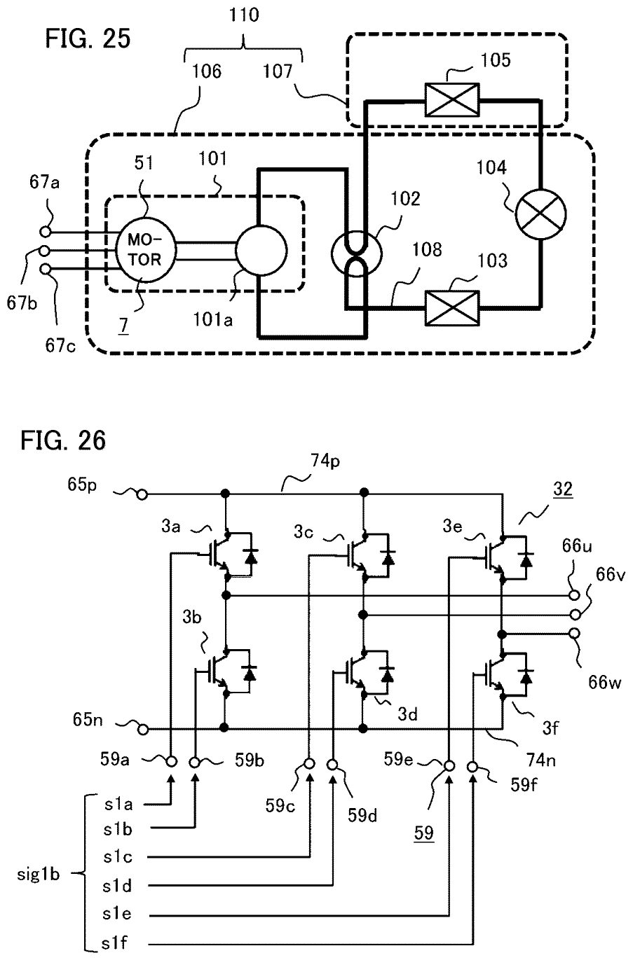

In FIG. 1, a DC variable resistor is shown as an example of the load 7. The load 7 is not limited to the DC variable resistor, and may be, for example, a constant current load or a constant power load. Alternatively, a motor (refer to FIG. 25) may be connected after the power is inversely converted to AC power by using an inverter (refer to FIG. 24). In this case, the combination of the inverter and the motor can be regarded as a DC variable resistor.

An LC filter 30 is disposed between the three-phase AC power supply 1 and DC input terminals 63p and 63n of the converter 31. More specifically, the LC filter 30 is disposed between the three-phase AC power supply 1 and the switching element 3 of the converter 31. That is, the power conversion device 50 includes the LC filter 30 between the AC input terminals 55r, 55s, and 55t, and the switching element 3. Here, a filter reactor 8 is disposed right after the rectifier circuit 2, and a filter capacitor 9 is disposed in the subsequent stage. The LC filter 30 serves to reduce a carrier ripple current generated in the converter 31 such as the step-down converter 31a and to reduce an outflow of the carrier ripple current to the power supply. The role of the LC filter 30 can also be described as follows. The LC filter 30 serves to reduce distortion of a power supply current Ips due to the carrier ripple current generated in the converter 31 such as the step-down converter 31a and to reduce current distortion of the power supply current Ips having a shape resembling “rabbit ears”, that is, a spike shape.

The power conversion device 50 of Embodiment 1 will be described in detail. The rectifier circuit 2 is a bridge rectifier circuit including, for example, six diodes 19a to 19f. Diodes 19a and 19b connected in series are for an arm of an r-phase of the three-phase AC, diodes 19c and 19d connected in series are for an arm of an s-phase of the three-phase AC, and diodes 19e and 19f connected in series are for an arm of a t-phase of the three-phase AC. An AC input terminal 61r is connected to a connection point of the diodes 19a and 19b, an AC input terminal 61s is connected to a connection point of the diodes 19c and 19d, and an AC input terminal 61t is connected to a connection point of the diodes 19e and 19f. Cathodes of the diodes 19a, 19c, and 19e are connected to a positive-side DC output terminal 62p, and anodes of the diodes 19b, 19d, and 19f are connected to a negative-side DC output terminal 62n. The rectifier circuit 2 outputs a DC output voltage Va from the DC output terminals 62p and 62n. The three-phase AC power supply 1 is connected to the AC input terminals 55r, 55s, and 55t of the power conversion device 50 through power lines 71r, 71s, and 71t. The reference signs for the power lines connected to the AC input terminals 55r, 55s, and 55t are collectively denoted by a reference numeral 71, and 71r, 71s, and 71t are used for distinction.

The AC input terminals 61r, 61s, and 61t of the rectifier circuit 2 are connected to the AC input terminals 55r, 55s, and 55t of the power conversion device 50, respectively. Input power P, that is, an interphase voltage Vac and the power supply current Ips of each phase are input from the three-phase AC power supply 1 to the AC input terminals 61r, 61s, and 61t of the rectifier circuit 2 via the power line 71 and the AC input terminals 55r, 55s, and 55t. The interphase voltage Vac and the power supply current Ips are an input voltage and an input current, respectively, which are input to the rectifier circuit 2 of the power conversion device 50. The interphase voltage Vac is a voltage between two phases of the three-phase AC input from the AC input terminals 55r, 55s, and 55t. The rectifier circuit 2 converts the input power P, that is, an input voltage (interphase voltage Vac) and an input current (power supply current Ips) of the three-phase AC power supply 1 input from the AC input terminals 55r, 55s, and 55t into DC power, that is, a DC voltage (output voltage Va) and a DC current. FIG. 1 shows the interphase voltage Vac between the s-phase and the t-phase. There are also interphase voltages Vac between the r-phase and the s-phase and between the r-phase and the t-phase.

The LC filter 30, the converter 31, and the smoothing capacitor 6 are sequentially arranged on the downstream side of the rectifier circuit 2, and the output voltage Vo of the smoothing capacitor 6 is output from the output terminals 57p and 57n of the power conversion device 50 to the load 7. The DC output terminal 62p of the rectifier circuit 2 is connected to the output terminal 57p of the power conversion device 50 by a positive-side line 73p in which the filter reactor 8 of the LC filter 30, and the switching element 3 and the control reactor 5 that are in the converter 31 are inserted. The DC output terminal 62n of the rectifier circuit 2 is connected to the output terminal 57n of the power conversion device 50 by a negative-side line 73n.

The LC filter 30 includes the filter reactor 8 and the filter capacitor 9, and is disposed between the AC input terminals 55r, 55s, and 55t, and the converter 31 of the power conversion device 50. FIG. 1 shows an example in which the LC filter 30 is disposed downstream of the rectifier circuit 2 connected to the AC input terminals 55r, 55s, and 55t. The filter reactor 8 of the LC filter 30 shown in FIG. 1 is disposed closer to the AC input terminals 55r, 55s, and 55t than the filter capacitor 9, and is connected between the DC output terminal 62p and a positive-side capacitor terminal 68p, the DC output terminal 62p being a positive-side rectifier circuit output terminal of the rectifier circuit 2, the positive-side capacitor terminal 68p being one end of the filter capacitor 9 connected to the DC input terminal 63p being the positive-side converter input terminal of the converter 31. More specifically, one end of the filter reactor 8 is connected to the DC output terminal 62p of the rectifier circuit, and the other end of the filter reactor 8 is connected by the positive-side line 73p to the positive-side capacitor terminal 68p being one end of the filter capacitor 9, and the DC input terminal 63p of the converter 31. A negative-side capacitor terminal 68n being the other end of the filter capacitor 9 is connected to the negative-side line 73n.

The converter 31 includes the DC input terminals 63p and 63n, the DC output terminals 64p and 64n, and a control terminal 58. In the step-down converter 31a, which is an example of the converter 31, the collector of the switching element 3 is connected to the DC input terminal 63p, and the emitter of the switching element 3 is connected to the cathode of the diode 4 and one end of the control reactor 5. The other end of the control reactor 5 is connected to the DC output terminal 64p. The anode of the diode 4 is connected to the negative-side line 73n, and is connected to the DC input terminal 63n and the DC output terminal 64n by the negative-side line 73n. The gate of the switching element 3 is connected to the control terminal 58. A control signal sig1, whose voltage value is changed by a drive circuit 25 on the basis of a gate signal command G* output from the controller 10, is input to the control terminal 58. The control signal sig1 is a signal for controlling an ON state and an OFF state of the switching element 3 by, for example, PWM control.

The controller 10 controls a control reactor current IL, which is a current of the control reactor 5 of the step-down converter 31a, and/or the output voltage Vo as aimed. Information of each of sensors to be detected by the power conversion device 50 is input to the controller 10. In this case, the output voltage Vo being the voltage of the smoothing capacitor 6 detected by a voltage sensor 11 is input to the controller 10 as voltage sensor information sig2, and the control reactor current IL being the current of the control reactor 5 detected by a current sensor 12 is input to the controller 10 as current sensor information sig3. The current sensor 12 for detecting the control reactor current IL of the control reactor 5 is disposed on the side of the DC input terminal 63p with respect to the control reactor 5. More specifically, the current sensor 12 is disposed between the emitter of the switching element 3 and the cathode of the diode 4, and one end of the control reactor 5 on the side of the DC input terminal 63p. The control reactor current IL is a current flowing through the positive-side line 73p, and thus is also a positive-side line current Ip.

The control signal sig1 is an operation signal for operating the switching element 3 in a predetermined state. In general, the control signal sig1 corresponds to the ON/OFF signal for controlling the switching element 3 to be in the ON state or the OFF state. Here, the signal is input to the switching element 3 via the drive circuit 25 for operating the switching element 3.

In order to control the step-down converter 31a, voltage information of the smoothing capacitor 6 and current information of the control reactor 5 are required. Here, the voltage information and the current information required for controlling the step-down converter 31a are the voltage sensor information sig2 of the smoothing capacitor 6 and the current sensor information sig3 of the control reactor 5 that are to be detected by using the voltage sensor 11 and the current sensor 12. However, the voltage information of the smoothing capacitor 6 and the current information of the control reactor 5 are not necessarily detected by using the voltage sensor 11 and the current sensor 12, and estimated values may be used instead.

FIG. 2 shows a configuration of the controller 10. The controller 10 determines a voltage command Vdc* to be an arbitrary value for controlling the output voltage Vo being the voltage of the smoothing capacitor 6.

The controller 10 obtains a voltage deviation ΔV, which is a deviation between the voltage command Vdc* of the smoothing capacitor 6 and a voltage detection value Vdc, which is a detection value of the output voltage Vo of the smoothing capacitor 6, by a subtractor 21. The voltage deviation ΔV is input to a voltage feedback control unit 22 that performs voltage feedback control. The voltage feedback control is often performed by proportional-integral control (PI control). The voltage feedback control may be performed by using proportional-integral-derivative control (PID control), proportional-derivative control (PD control), or the like, or may be performed by using another combination of proportional control (P control), integral control (I control), and derivative control (D control). Note that, in the figures, “feedback” of the voltage feedback control unit and the current feedback control unit is denoted as “FB”.

In Embodiment 1, since the converter 31 is the step-down converter 31a, the voltage command Vdc* needs to be set to be smaller than the voltage of the filter capacitor 9 input to the step-down converter 31a. When the voltage command Vdc* is set to be larger than the voltage of the filter capacitor 9, the switching element 3 is always in the ON state, resulting in the same as the normal rectifying operation, and the output voltage from the step-down converter 31a is the same as the voltage input thereto, and cannot be stepped up to the set voltage of the voltage command Vdc*.

An output of the voltage feedback control unit 22 is output as a current command IL* for the control reactor 5. A current deviation ΔI, which is a deviation between the current command IL* for the control reactor 5 and the detection value of the control reactor current IL of the control reactor 5, is obtained by the subtractor 21 in a subsequent stage of the voltage feedback control unit 22. The current deviation ΔI is input to a current feedback control unit 23 that performs current feedback control. The current feedback control often uses PI control (proportional-integral control). The current feedback control may use PID control, PD control, or the like similarly to the voltage feedback control, and may use another combination of P control, I control, and D control. The output of the current feedback control unit 23 is output as an on-duty command D*. The current feedback control unit 23 generates the on-duty command D* for controlling the current flowing through the control reactor 5, that is, the control reactor current IL, to be within a predetermined current setting range RaI (refer to FIG. 6). The power conversion device 50 of Embodiment 1 can control the power supply current Ips of the three-phase AC power supply 1 to have a rectangular wave shape, that is, a rectangular wave current, by controlling the control reactor current IL to be within the current setting range RaI. The current feedback control by the current feedback control unit 23 needs to be designed to be as highly responsive as possible in order to make the power supply current Ips have a rectangular wave shape. As for the current control, it is possible to perform the control with higher accuracy by using repetitive control.

The controller 10 inputs the on-duty command D* and a carrier wave 26 to a carrier comparison unit 24. As the carrier wave 26, a triangular wave from 5 kHz to 20 kHz is often used. Although FIG. 2 shows an example in which the carrier wave 26 is a triangular wave, the carrier wave 26 may be a sawtooth wave.

The carrier comparison unit 24 compares the on-duty command D* with the carrier wave 26, and when the on-duty command D* is larger than the carrier wave 26, the carrier comparison unit 24 outputs a gate signal command G* for turning the switching element 3 in the ON state. Conversely, when the on-duty command D* is smaller than the carrier wave 26, the carrier comparison unit 24 outputs the gate signal command G* for turning the switching element 3 in the OFF state. The gate signal command G* is a command having a duty ratio D as shown in FIG. 3. The gate signal command G* is typically generated using a PWM function installed on a microcomputer, or generated by a field-programmable gate array (FPGA), an application specific integrated circuit (ASIC), or the like.

The duty ratio D will be described. A pulse wave of the gate signal command G* as a digital signal is shown in FIG. 3. The duty ratio D is obtained by dividing a high period Th, which is a period during which the gate signal command G* is a high voltage (digital value of 1), by a switching period Tsw of the gate signal command G*. That is, the duty ratio D is expressed by Th/Tsw. The duty ratio D of the control signal sig1, which is a digital signal with the changed voltage value, is similarly expressed in Th/Tsw. The switching period Tsw is the period of the carrier wave 26.

When the switching element 3 is driven by the control signal sig1 based on the gate signal command G* output from the controller 10, the step-down converter 31a can be controlled so as to output a desired voltage value.

The control block diagram of the controller 10 shown in FIG. 2 is an example of a control method for controlling the converter 31, and this control method does not necessarily need to be used, and the voltage control system, that is, the voltage feedback control unit 22, may be omitted, or the current control system, that is, the current feedback control unit 23, may be omitted. However, in order to control the output voltage Vo, which is the voltage of the smoothing capacitor 6, with high accuracy, it is desirable to include the voltage control system, that is, the voltage feedback control unit 22. In addition, in order to cause the power supply current Ips of the three-phase AC power supply 1 to have a rectangular wave shape, it is desirable to include the current control system, that is, the current feedback control unit 23.

Next, operation waveforms of the power conversion device 50 of Embodiment 1 will be described in comparison with Comparative Example 1 to Comparative Example 3. FIG. 5 to FIG. 7 show operation waveforms of the power conversion device 50 of Embodiment 1. FIG. 8 to FIG. 11 show operation waveforms of a power conversion device of Comparative Example 1. FIG. 12 to FIG. 14 show operation waveforms of a power conversion device of Comparative Example 2, and FIG. 15 to FIG. 17 show operation waveforms of a power conversion device of Comparative Example 3. Note that the operation waveforms of the power conversion device 50 of Embodiment 1 are referred to as operation waveforms of Example 1 as appropriate. The power conversion devices of Comparative Example 1 to Comparative Example 3 are different from the power conversion device 50 of Embodiment 1 in the filter inductance Lf of the filter reactor 8 and the filter capacitance Cf being the electrostatic capacitance of the filter capacitor 9 in the LC filter 30. The common conditions of Example 1 and Comparative Example 1 to Comparative Example 3 are as follows. As AC output conditions of the three-phase AC power supply 1, the interphase voltage Vac is 600 V, and the AC power supply frequency Fps is 60 Hz. The carrier frequency Fca of the carrier wave 26 is 20 kHz. The command value of the voltage command Vdc* is 600 V. The filter inductance Lf and the filter capacitance Cf of Example 1 and Comparative Example 1 to Comparative Example 3 are as follows. The filter inductance Lf and the filter capacitance Cf of Example 1 are 200 μH and 10 μF, respectively. The filter inductance Lf and the filter capacitance Cf of Comparative Example 1 are 0 pH and 10 μF, respectively. The filter inductance Lf and the filter capacitance Cf of Comparative Example 2 are 4000 μH and 10 μF, respectively. The filter inductance Lf and the filter capacitance Cf of Comparative Example 3 are 10 μH and 200 μF, respectively.

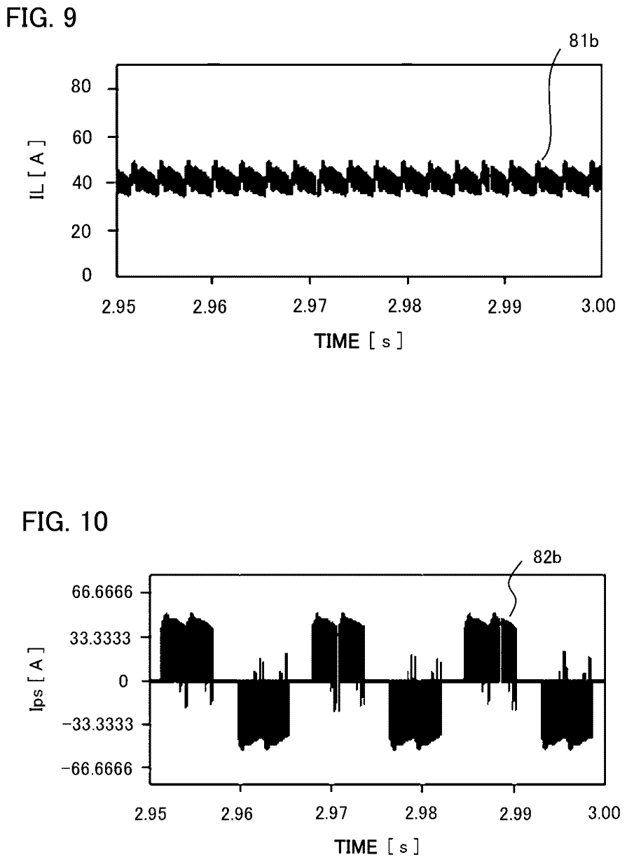

First, the operation waveforms of Comparative Example 1 shown in FIG. 8 to FIG. 11 will be described. The operation waveforms of Comparative Example 1 are operation waveforms in a case where the filter inductance Lf is 0 μH and thus the filter reactor 8 is not provided. FIG. 8 shows a voltage characteristic 80b of the output voltage Vo. FIG. 9 and FIG. 10 show a current characteristic 81b of the control reactor current IL and a current characteristic 82b of the power supply current Ips, respectively. The power supply current Ips is a current for one phase of the three-phase AC. FIG. 11 shows a current characteristic 83 that is an enlarged waveform around the time 2.985 [s] in the power supply current Ips of FIG. 10. In FIG. 8 to FIG. 11, the horizontal axis represents time [s]. The vertical axis of FIG. 8 represents the output voltage Vo [V], the vertical axis of FIG. 9 represents the control reactor current IL [A], and the vertical axis of FIG. 10 represents the power supply current Ips [A].

The voltage characteristic 80b of the output voltage Vo of Comparative Example 1 is kept constant at 600V as per the command value of the voltage command Vdc*. The current characteristic 81b of the control reactor current IL of the control reactor 5 can be controlled to be substantially constant, and this can also be controlled without any problem. However, the current characteristic 82b of the power supply current Ips is band-shaped. As shown in FIG. 11, the current characteristic 83 of the band-shaped power supply current Ips oscillates repeatedly between 0 A (zero level), and 40 A to 50 A, and it is found that the current characteristic 83 exhibits significant fluctuation. This state means that the filter capacitor 9 cannot sufficiently remove the carrier ripple current generated in the step-down converter 31a, that is, the filter capacitor 9 cannot sufficiently absorb the carrier ripple current. In such a state, if a device having a capacitive component such as a capacitor is connected to the input side of the power conversion device of Comparative Example 1, the carrier ripple current may flow into the device and cause the device to be broken.

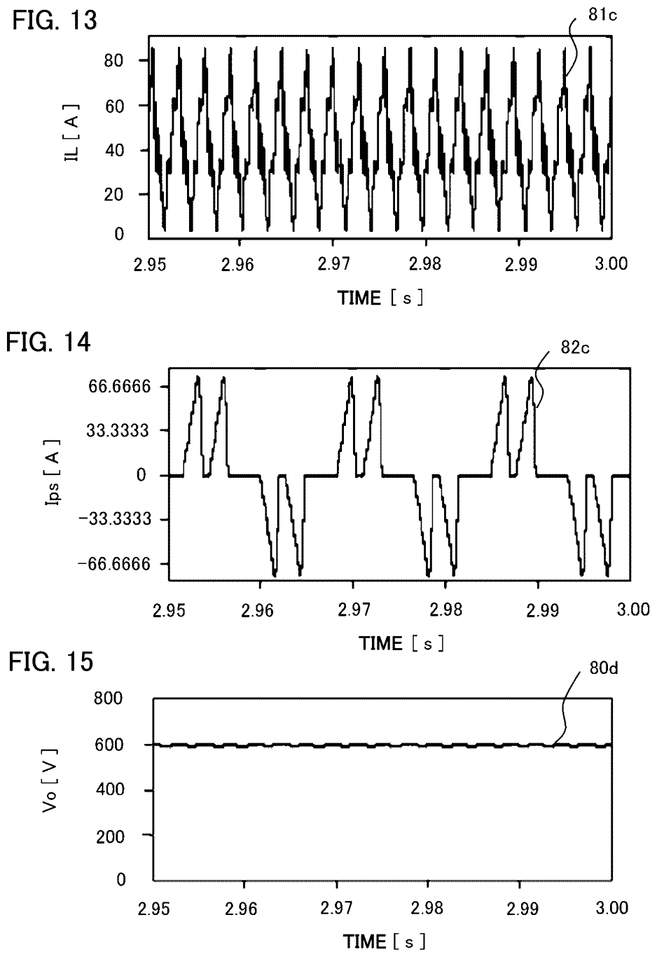

Next, operation waveforms of Comparative Example 2 shown in FIG. 12 to FIG. 14 will be described. The operation waveforms of Comparative Example 2 are operation waveforms in the case where the filter reactor 8 having the filter inductance Lf of 4000 pH is present. FIG. 12 shows a voltage characteristic 80c of the output voltage Vo. FIG. 13 and FIG. 14 show a current characteristic 81c of the control reactor current IL and a current characteristic 82c of the power supply current Ips, respectively. The power supply current Ips is a current for one phase of the three-phase AC. In FIG. 12 to FIG. 14, the horizontal axis represents time [s]. The vertical axis of FIG. 12 represents the output voltage Vo [V], the vertical axis of FIG. 13 represents the control reactor current IL [A], and the vertical axis of FIG. 14 represents the power supply current Ips [A]. In the case of Comparative Example 2, the control reactor current IL of the control reactor 5 and the power supply current Ips fluctuate greatly, and the current in a manner resembling “rabbit ears” flows as the power supply current Ips. Further, the voltage characteristic 80c of the output voltage Vo fluctuates as compared with the voltage characteristic 80b of the output voltage Vo of Comparative Example 1. Since an excessive current flows in the power conversion device of Comparative Example 2, this is not a desirable operation. In order to prevent the power conversion device of Comparative Example 2 from being broken, it is necessary to increase the current rating for the components of the rectifier circuit and the step-down converter.

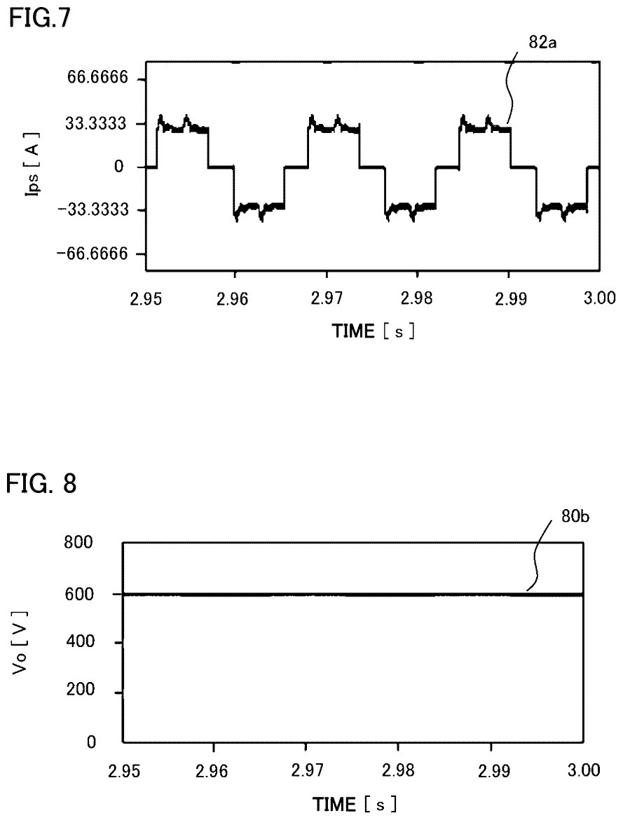

Next, operation waveforms of Example 1 shown in FIG. 5 to FIG. 7 will be described. The operation waveforms of Embodiment 1 are operation waveforms in the case where the filter reactor 8 having the filter inductance Lf of 200 μH is present. FIG. 5 shows a voltage characteristic 80a of the output voltage Vo. FIG. 6 and FIG. 7 show a current characteristic 81a of the control reactor current IL and a current characteristic 82a of the power supply current Ips, respectively. The power supply current Ips is a current for one phase of the three-phase AC. In FIG. 5 to FIG. 7, the horizontal axis represents time [s]. The vertical axis of FIG. 5 represents the output voltage Vo [V], the vertical axis of FIG. 6 represents the control reactor current IL [A], and the vertical axis of FIG. 7 represents the power supply current Ips [A]. In the case of Example 1, the ripple of the control reactor current IL of the control reactor 5 is smaller than that of Comparative Example 2, and it is understood that the carrier ripple current of the power supply current Ips can also be removed. The result of Example 1 is in a desirable state compared to Comparative Example 1 to Comparative Example 3, and the operation waveforms of Example 1 show a state where appropriate parameters are set for the filter inductance Lf of the filter reactor 8 and the filter capacitance Cf of the filter capacitor 9.

Finally, operation waveforms of Comparative Example 3 shown in FIG. 15 to FIG. 17 will be described. The operation waveforms of Comparative Example 3 are operation waveforms when the balance between the filter inductance Lf and the filter capacitance Cf is lost as compared with Example 1. The filter inductance Lf and the filter capacitance Cf of Comparative Example 3 are 10 μH and 200 μF, respectively. The resonant frequency Fre of the LC filter of Comparative Example 3 is the same as the resonant frequency Fre of the LC filter 30 of Example 1. The resonant frequency Fre [Hz] is expressed by Equation (1).

Fre=1/(2π×√(Lf×Cf) (1)

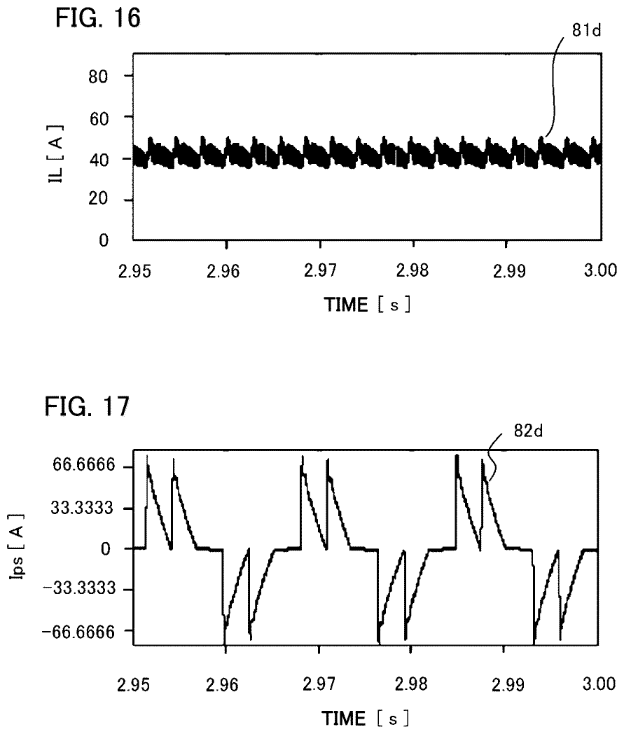

FIG. 15 shows a voltage characteristic 80d of the output voltage Vo. FIG. 16 and FIG. 17 show a current characteristic 81d of the control reactor current IL and a current characteristic 82d of the power supply current Ips, respectively. The power supply current Ips is a current for one phase of the three-phase AC. In FIG. 15 to FIG. 17, the horizontal axis represents time [s]. The vertical axis of FIG. 15 represents the output voltage Vo [V], the vertical axis of FIG. 16 represents the control reactor current IL [A], and the vertical axis of FIG. 17 represents the power supply current Ips [A]. In the case of Comparative Example 3, the output voltage Vo fluctuates as compared with the Example 1. Further, it is found that the current characteristic 82d of the power supply current Ips has a larger waveform distortion than the current characteristic 82a of the power supply current Ips of Example 1, similarly to Comparative Example 2.

A method of setting the parameters of the LC filter 30, that is, the filter inductance Lf and the filter capacitance Cf will be described. First, in consideration of the removal of the carrier ripple current, the LC filter 30 including the filter reactor 8 and the filter capacitor 9 is operated as a low pass filter to remove the carrier ripple current generated in the step-down converter 31a. The resonant frequency Fre of the LC filter 30 should be set to be lower than the carrier frequency Fca so that attenuation is effective in the band of the carrier frequency Fca. For example, when the resonant frequency Fre is set to be equal to or lower than half the carrier frequency Fca, the current passing through the LC filter 30 in the band of the carrier frequency Fca can be attenuated. Therefore, in order to remove the carrier ripple current, the upper limit of the resonant frequency Fre of the LC filter 30 should be half of the carrier frequency Fca.

Next, a method of reducing the distortion of the power supply current Ips will be considered. When the AC power is converted into the DC power by using the rectifier circuit 2, if the resonant frequency Fre of the LC filter 30 is low, a spike-shaped current including harmonics such as “rabbit ears” is generated in the power supply current Ips. If the filter inductance Lf of the filter reactor 8 is increased as a countermeasure against this, the power supply current Ips is rounded to have a rectangular waveform. However, when the power supply current Ips is made to have a rectangular waveform by taking measures only with the filter inductance Lf, the filter inductance Lf becomes too large, and thus the size of the LC filter 30 increases and the cost also increases.

Therefore, as another method of reducing the distortion of the power supply current Ips, there is a method of increasing the resonant frequency Fre of the LC filter 30. The resonant frequency Fre is preferably higher than the power supply frequency Fps, but if the resonant frequency Fre is approximately 18 times or more the power supply frequency Fps, the power supply current Ips can be regarded as a rectangular wave current. When the resonant frequency Fre are 18 times or more the power supply frequency Fps, unlike the current characteristic 82c of the power supply current Ips in Comparative Example 2, a plurality of current rises can be eliminated even if there is some fluctuation during one cycle of the power supply current Ips of each phase. Therefore, in order to reduce the distortion of the power supply current Ips and to make the power supply current Ips a rectangular wave current, the lower limit of the resonant frequency Fre of the LC filter 30 should be 18 times the power supply frequency Fps. If the filter capacitance Cf of the filter capacitor 9 is too large, the power supply current Ips does not become a rectangular wave current as in the current characteristic 82d of the power supply current Ips of Comparative Example 3. Therefore, a film capacitor having a small filter capacitance Cf and a large current rating should be used as the filter capacitor 9.

The resonant frequency Fre of the LC filter 30 should satisfy both of a condition that is equal to or lower than half the carrier frequency Fca and a condition that is equal to or higher than 18 times the power supply frequency Fps. For example, the parameters of the LC filter 30 in the power conversion device 50 according to Embodiment 1, that is, the filter inductance Lf and the filter capacitance Cf are Lf=200 μH and Cf=10 μF. The resonant frequency Fre can be calculated from Equation (1). In this case, the resonant frequency Fre is about 3600 Hz, which is about one fourth of the carrier frequency Fca and 60 times the power supply frequency Fps. The output voltage Vo, the control reactor current IL, and the power supply current Ips in the power conversion device 50 according to Embodiment 1 can be made to have the characteristics shown in FIG. 5, FIG. 6, and FIG. 7.

Although the output of the rectifier circuit 2 includes a ripple containing components of a multiple of 6 (6 times, 12 times, 18 times, or the like) of the power supply frequency Fps, the resonant frequency Fre of the LC filter 30 is preferably high in order to improve the characteristics of the rectifier circuit 2. When the resonant frequency Fre of the LC filter 30 is increased from six times the power supply frequency Fps to three times further thereof, that is, to 18 times the power supply frequency Fps, the output of the rectifier circuit 2 can obtain a favorable characteristic.

When the filter capacitance Cf [F] of the filter capacitor 9 is designed in a range in which Equation (2) is satisfied using the interphase voltage Vac [V] and the input power P [W] in the three-phase AC power supply 1, the LC filter 30 can obtain a favorable characteristic. The input power P should be a rated power or a maximum power.

Cf≤P/Vac²×0.001 (2)

When the filter capacitance Cf of the filter capacitor 9 is proportional to the power to be input, and inversely proportional to the square of the power supply voltage, and an electrostatic capacitance is equal to or less than 1/1000 of that, the LC filter 30 can exhibit a favorable characteristic. The reason why the capacitance is made proportional to the power and inversely proportional to the square of the power supply voltage is to make the waveform shape of the power supply current Ips itself the same even if the power and the power supply voltage change.

The lower limit electrostatic capacitance of the filter capacitor 9, that is, a lower limit filter capacitance Cfmin being the lower limit of the filter capacitance Cf can be obtained from Equation (1) and half of the carrier frequency Fca being the upper limit of the resonant frequency Fre. The lower limit filter capacitance Cfmin is 1/(Lf×π²×Fca²). Therefore, the filter capacitance Cf [F] of the filter capacitor 9 should be set in a range satisfying Equation (2) and Equation (3).

Cf≥1/(Lf×π²×Fca²) (3)

In the power conversion device 50 according to Embodiment 1, the converter 31 includes the switching element 3 that is controlled with PWM by the control signal sig1 generated on the basis of the carrier wave 26 and the on-duty command D*. The resonant frequency Fre of the LC filter 30 is set to be equal to or greater than a predetermined lower limit frequency Fremin and to be equal to or less than half of the carrier frequency Fca of the carrier wave 26. The lower limit frequency Fremin of the resonant frequency Fre is a frequency of 18 times the frequency of the three-phase AC, the frequency of the three-phase AC being the power supply frequency Fps. That is, the setting condition of the LC filter 30 in Embodiment 1 is that, using the resonant frequency Fre, the resonant frequency Fre is equal to or higher than the lower limit frequency Fremin and equal to or lower than half of the carrier frequency Fca of the carrier wave 26. Further, the setting condition of the filter capacitance Cf of the filter capacitor 9 in the LC filter 30 in Embodiment 1 is in a range satisfying Equation (2) and Equation (3).

The power conversion device 50 of Embodiment 1 can prevent the breakage of the peripheral devices by reducing the outflow of the carrier ripple current. Further, by reducing the distortion of the power supply current Ips, component losses can be reduced, and a component with a small current rating can be applied.

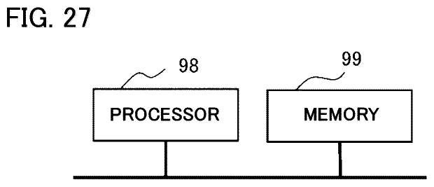

Note that functions of the subtractor 21, the voltage feedback control unit 22, the current feedback control unit 23, and the carrier comparison unit 24, which are functional blocks of the controller 10, may be implemented by a processor 98 and a memory 99 shown in FIG. 27. FIG. 27 is a diagram showing an example of a hardware configuration for implementing the functions of the controller by digital computation. In this case, the subtractor 21, the voltage feedback control unit 22, the current feedback control unit 23, and the carrier comparison unit 24 are implemented by the processor 98 executing a program stored in the memory 99. In addition, a plurality of the processors 98 and a plurality of the memories 99 may execute each function in cooperation with each other.

Note that the switching element 3 may be a silicon semiconductor element formed using silicon or a wide bandgap semiconductor element formed using a wide bandgap semiconductor material having a bandgap larger than that of silicon. Examples of the wide bandgap semiconductor material include silicon carbide (SiC), gallium nitride material such as gallium nitride (GaN), and diamond. As a semiconductor material for the diode 4, silicon or a wide bandgap semiconductor material can be used as in the case of the switching element 3. When the switching element 3 and the diode 4 are semiconductor elements formed of a wide bandgap semiconductor material, that is, wide bandgap semiconductor elements, the switching speed and the operation speed are higher and the loss such as the switching loss is smaller than those of silicon semiconductor elements. Further, the wide bandgap semiconductor elements have higher voltage resistance and higher heat resistance than the silicon semiconductor elements. Therefore, when the switching element 3 and the diode 4 are the wide bandgap semiconductor elements, a heat sink or the like that is a cooler for the switching element 3 and the diode 4 can be downsized, or the heat sink or the like may be unnecessary.

As described above, the power conversion device 50 of Embodiment 1 includes the rectifier circuit 2 that converts the input voltages (interphase voltage Vac) of the three-phase AC input from the AC input terminals 55r, 55s, and 55t into the DC voltage, the converter 31 that outputs the output voltage Vo set to the set voltage value from the DC voltage output from the rectifier circuit 2, the smoothing capacitor 6 connected between the positive-side converter output terminal (DC output terminal 64p) and the negative-side converter output terminal (DC output terminal 64n) of the converter 31 from which the output voltage Vo is output, the LC filter 30 including the filter reactor 8 and the filter capacitor 9 and disposed between the AC input terminals 55r, 55s, and 55t, and the converter 31, and the controller 10 that controls the converter 31. The filter reactor 8 is disposed closer to the AC input terminals 55r, 55s, and 55t than the filter capacitor 9. In the power conversion device 50 of Embodiment 1, with this configuration, since the LC filter 30 including the filter reactor 8 and the filter capacitor 9 is disposed between the AC input terminals 55r, 55s, and 55t, and the converter 31, and the filter reactor 8 is disposed closer to the AC input terminals 55r, 55s, and 55t than the filter capacitor 9, it is possible to reduce the carrier ripple current and to reduce the outflow of the carrier ripple current to the power supply.

### Embodiment 2

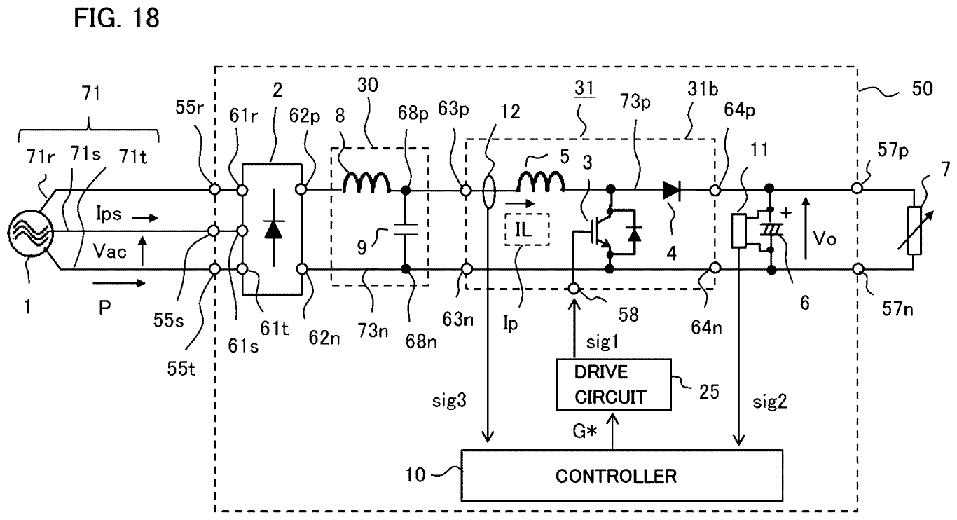

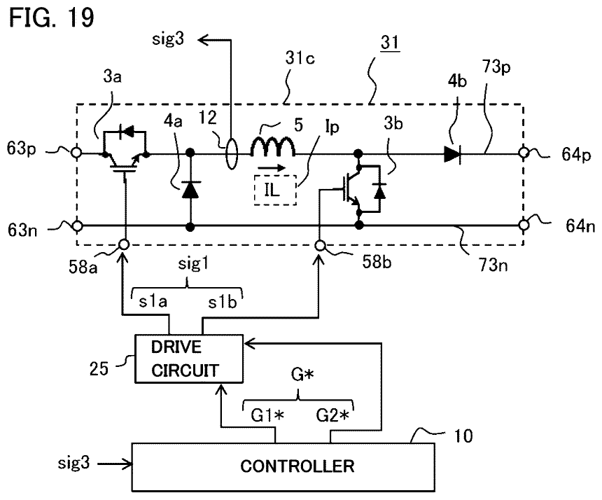

FIG. 18 is a diagram showing a configuration of a power conversion device according to Embodiment 2, and FIG. 19 is a diagram showing a configuration of another example of the converter of FIG. 18. The power conversion device 50 of Embodiment 2 is different from the power conversion device 50 of Embodiment 1 in that the converter 31 is a step-up converter 31b or a step-up/step-down converter 31c. The differences from the power conversion device 50 of Embodiment 1 will be mainly described.

FIG. 18 shows an example in which the converter 31 is the step-up converter 31b. FIG. 19 shows an example in which the converter 31 is a step-up/step-down converter 31c. In the step-up converter 31b, which is an example of the converter 31, one end of the control reactor 5 is connected to the positive DC input terminal 63p, and the other end of the control reactor 5 is connected to the collector of the switching element 3 and the anode of the diode 4. The cathode of the diode 4 is connected to the positive-side DC output terminal 64p. The control reactor 5 and the diode 4 are inserted in the positive-side line 73p. The emitter of the switching element 3 is connected to the negative-side line 73n, and is connected to the DC input terminal 63n and the DC output terminals 64n by the negative-side line 73n. The gate of the switching element 3 is connected to the control terminal 58. The control terminal 58 receive the control signal sig1 whose voltage value is changed by the drive circuit 25 on the basis of the gate signal command G* output from the controller 10. The control signal sig1 is a signal for controlling the ON state and the OFF state of the switching element 3 by, for example, PWM control. The current sensor 12 for detecting the control reactor current IL being the current of the control reactor 5 is disposed between the DC input terminal 63p and one end of the control reactor 5.

The LC filter 30 serves to reduce a carrier ripple current generated in the converter 31 such as the step-up converter 31b and to reduce the outflow of the carrier ripple current to the power supply. Further, the role of the LC filter 30 can also be described as follows. The LC filter 30 serves to reduce distortion of the power supply current Ips due to the carrier ripple current generated in the converter 31 such as the step-up converter 31b, and to reduce current distortion of the power supply current Ips in a shape resembling “rabbit ears”, that is, a spike shape.

The configuration of the controller 10 is the same as that of Embodiment 1. Since the same control configuration as that of Embodiment 1 can be used, a detailed description thereof will be omitted. However, the voltage command Vdc* for controlling the output voltage Vo being the voltage of the smoothing capacitor 6 is determined to be an arbitrary value. Since the converter 31 is the step-up converter 31b, the voltage command Vdc* should be set to be larger than the voltage of the filter capacitor 9 input to the step-up converter 31b.

The input side of the step-up converter 31b is the control reactor 5, and a waveform such as a triangular wave is input to the step-up converter 31b, and therefore, the generated carrier ripple current is smaller than that of the step-down converter 31a. However, the LC filter 30 and the method of selecting the parameters of the LC filter 30 described in Embodiment 1 are effective in reducing the carrier ripple current and the outflow of the carrier ripple current to the power supply.

Note that, although FIG. 18 shows an example in which the step-up converter 31b has a two-level configuration, it is needless to say that the number of switching elements 3 can be increased to have a three-level configuration, etc. in which a plurality of the switching elements 3 are connected in series. Similarly, the step-down converter 31a described in Embodiment 1 may be set to be the three-level. The converter 31 may be the step-up/step-down converter 31c having both the function of the step-up converter 31b and the function of the step-down converter 31a.

The step-up/step-down converter 31c shown in FIG. 19 includes two switching elements 3a and 3b, the control reactor 5, and two diodes 4a and 4b. The configuration including the switching element 3a, the diode 4a, and the control reactor 5 is the same as that of the step-down converter 31a described in Embodiment 1. The configuration including the control reactor 5, the switching element 3b, and the diode 4b is the same as that of the step-up converter 31b shown in FIG. 18. In the step-up/step-down converter 31c, the collector of the switching element 3a is connected to the DC input terminal 63p, and the emitter of the switching element 3a is connected to the cathode of the diode 4a and one end of the control reactor 5. The other end of the control reactor 5 is connected to the collector of the switching element 3b and the anode of the diode 4b. The cathode of the diode 4b is connected to the DC output terminal 64p. The anode of the diode 4a and the emitter of the switching element 3b are connected to the negative-side line 73n, and are connected to the DC input terminal 63n and the DC output terminal 64n by the negative-side line 73n. The switching element 3a, the control reactor 5, and the diode 4b are inserted into the positive-side line 73p. The gate of the switching element 3a is connected to a control terminal 58a, and the gate of the switching element 3b is connected to a control terminal 58b.

The control terminals 58a and 58b receive a control signal sig1 whose voltage value is changed by the drive circuit 25 on the basis of the gate signal command G* output from the controller 10. To be more specific, the control signal s1a whose voltage value is changed by the drive circuit 25 on the basis of the gate signal command G1* output from the controller 10 is input to the control terminal 58a. The control signal s1b whose voltage value is changed by the drive circuit 25 on the basis of the gate signal command G2* output from the controller 10 is input to the control terminal 58b. The reference signs for the control signals input to the control terminals 58a and 58b are collectively denoted by sig1, and the reference signs s1a and s1b are used for distinction. The reference signs for the gate signal commands output from the controller 10 are collectively denoted by G*, and are distinguished by G1* and G2*. The current sensor 12 for detecting the control reactor current IL being the current of the control reactor 5 is disposed between the emitter of the switching element 3a and the cathode of the diode 4a, and one end of the control reactor 5. The control reactor current IL detected by the current sensor 12 is also the current flowing through the positive-side line 73p, and thus is also the positive-side line current Ip, as with the control reactor current IL shown in FIG. 1 and FIG. 18. The control signal sig1 is a signal for controlling the ON state and the OFF state for the switching elements 3a and 3b by, for example, PWM control. When the step-up/step-down converter 31c is caused to function as a step-down converter, the switching element 3b is turned in the OFF state, and the switching element 3a is controlled to be in the ON state and the OFF state. When the step-up/step-down converter 31c is caused to function as a step-up converter, the switching element 3a is turned in the ON state, and the switching element 3b is controlled to be in the ON state and the OFF state. Note that, although FIG. 19 shows an example in which the step-up/step-down converter 31c has the two-level configuration, it is needless to say that the number of switching elements 3 can be increased to have a three-level configuration, etc. in which a plurality of the switching elements 3 are connected in series.

The power conversion device 50 of Embodiment 2 can prevent the breakage of the peripheral devices by reducing the outflow of the carrier ripple current, as in the power conversion device 50 of Embodiment 1. Further, by reducing the distortion of the power supply current Ips, component losses can be reduced, and a component with a small current rating can be applied In the power conversion device 50 of Embodiment 2, the LC filter 30 including the filter reactor 8 and the filter capacitor 9 is disposed between the AC input terminals 55r, 55s, and 55t, and the converter 31, and the filter reactor 8 is disposed closer to the AC input terminals 55r, 55s, and 55t than the filter capacitor 9. Therefore, it is possible to reduce the carrier ripple current and to reduce the outflow of the carrier ripple current to the power supply.

### Embodiment 3

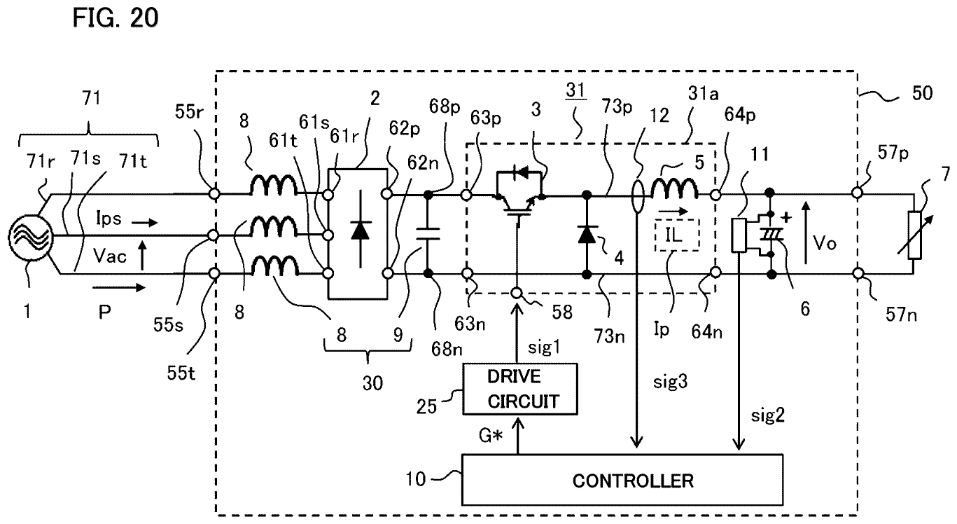

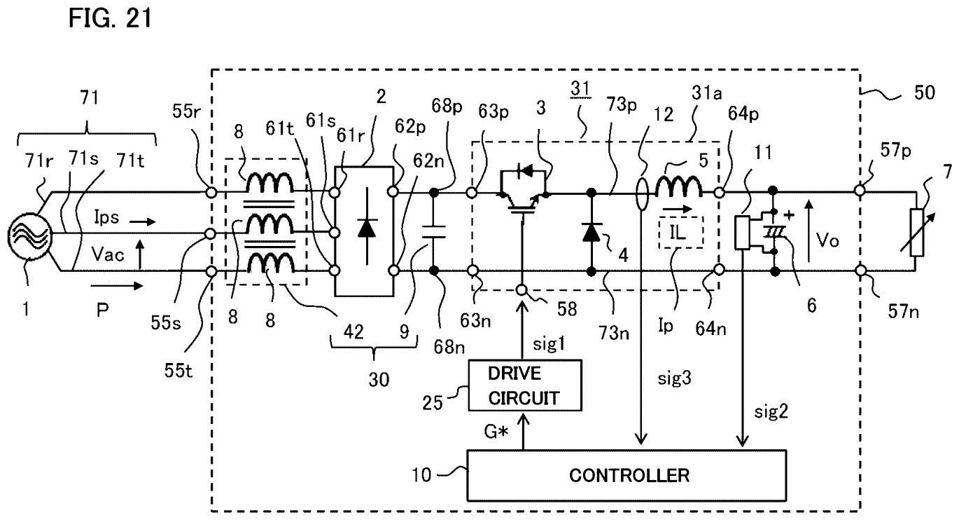

FIG. 20 is a diagram showing a configuration of a first power conversion device according to Embodiment 3, and FIG. 21 is a diagram showing a configuration of a second power conversion device according to Embodiment 3. In Embodiment 1 and Embodiment 2, the examples are shown in which the filter reactor 8 of the LC filter 30 is disposed between the rectifier circuit 2 connected to the AC input terminals 55r, 55s, and 55t, and the converter 31. However, the filter reactor 8 may be disposed between the AC input terminals 55r, 55s, and 55t, and the rectifier circuit 2. The power conversion device 50 of Embodiment 3 is different from the power conversion devices 50 of Embodiment 1 and Embodiment 2 in that the filter reactor 8 is disposed between the AC input terminals 55r, 55s, and 55t, and the rectifier circuit 2. The following description will focus on differences from the power conversion devices 50 of Embodiment 1 and Embodiment 2.

In the first power conversion device 50 of Embodiment 3 shown in FIG. 20, a first filter reactor 8 is connected between the AC input terminal 55r and the AC input terminal 61r being a rectifier circuit input terminal of the rectifier circuit 2. Similarly, a second filter reactor 8 is connected between the AC input terminal 55s and the AC input terminal 61s being a rectifier circuit input terminal of the rectifier circuit 2, and a third filter reactor 8 is connected between the AC input terminal 55t and the AC input terminal 61t being a rectifier circuit input terminal of the rectifier circuit 2. The LC filter 30 of Embodiment 3 includes three filter reactors 8 and the filter capacitor 9, with the rectifier circuit 2 interposed between the reactors and the filter capacitor. The three filter reactors 8 shown in FIG. 20 are on the AC side (alternating current side), and therefore can be referred to as AC reactors.

Although a total of three filter reactors 8 are required on the AC side because three-phase AC is input, the LC filter 30 can be effectively operated even in such a configuration. Note that the value of the filter inductance Lf of the filter reactor 8 is doubled because the current passes through the filter reactor 8 twice in the forward and backward directions.

Further, the second power conversion device 50 of Embodiment 3 may have a configuration as shown in FIG. 21. The reactor of a common mode choke coil 42 to be installed for noise removal can be used as the filter reactor 8. In the second power conversion device 50 of Embodiment 3, the filter reactors 8 are connected between the AC input terminals 55r, 55s, and 55t, and the AC input terminals 61r, 61s, and 61t being the rectifier circuit input terminals of the rectifier circuit 2, and the three filter reactors 8 corresponding to the respective phases of the three-phase AC constitute the common mode choke coil 42. The common mode choke coil 42 is normally effective for the common mode, but can be used for the normal mode because it has a slight inductance.

The power conversion device 50 of Embodiment 3 can prevent the breakage of the peripheral devices by reducing the outflow of the carrier ripple current, similarly to the power conversion devices 50 of Embodiment 1 and Embodiment 2. Furthermore, by reducing the distortion of the power supply current Ips, component losses can be reduced, and a component with a small current rating can be applied In the power conversion device 50 of Embodiment 3, the LC filter 30 including the three filter reactors 8 and the filter capacitor 9 is disposed between the AC input terminals 55r, 55s, and 55t, and the converter 31, and the three filter reactors 8 are disposed closer to the AC input terminals 55r, 55s, and 55t than the filter capacitor 9, with the rectifier circuit 2 interposed between the filter reactors and filter capacitor. Therefore, it is possible to reduce the carrier ripple current and to reduce the outflow of the carrier ripple current to the power supply.

### Embodiment 4

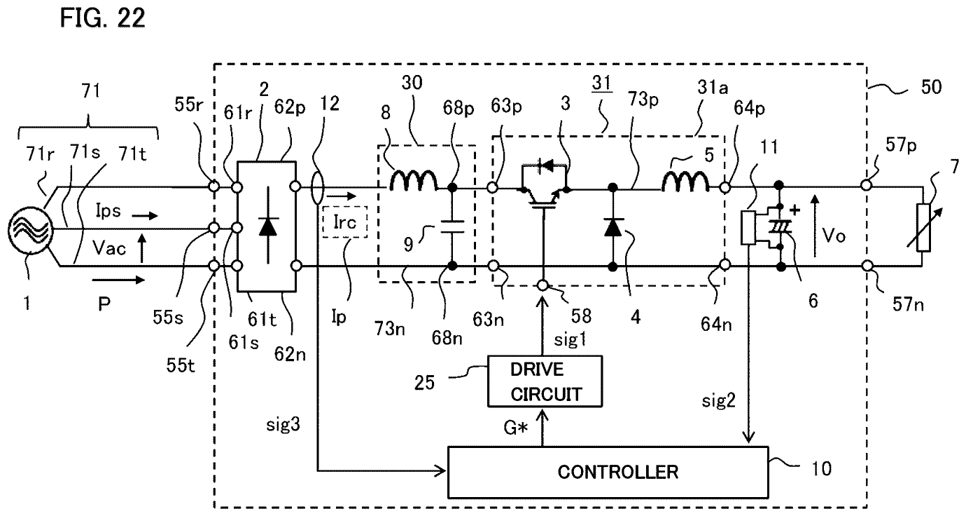

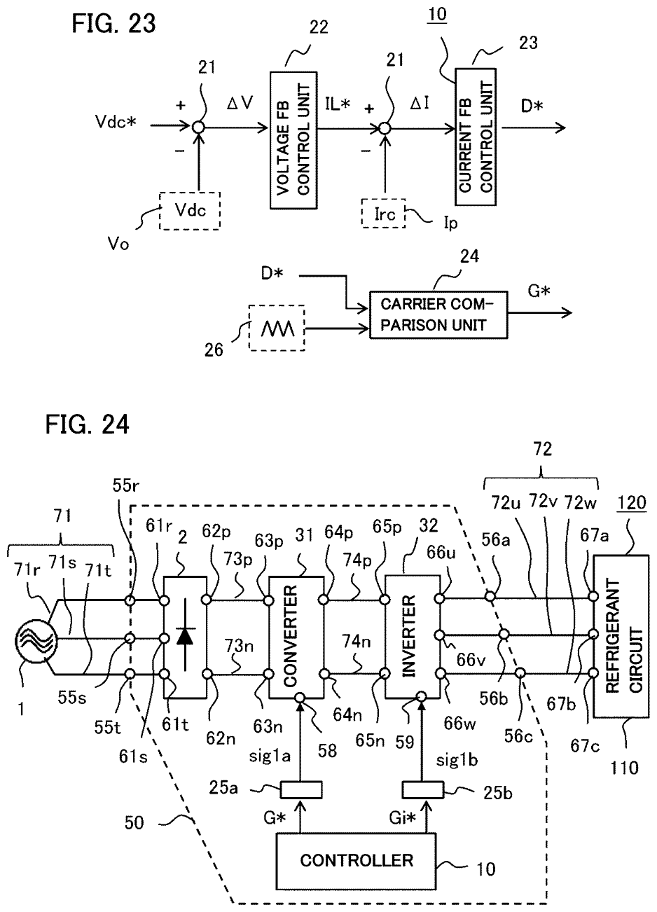

FIG. 22 is a diagram showing a configuration of a power conversion device according to Embodiment 4, and FIG. 23 is a diagram showing a configuration of a controller according to Embodiment 4. In the power conversion device 50 according to Embodiment 1 and Embodiment 2, the example is shown in which the current sensor 12 detects the control reactor current IL as the positive-side line current Ip flowing through the positive-side line 73p. However, the current sensor 12 may detect a rectifier circuit current Irc being the current flowing through the filter reactor 8 and the output current from the rectifier circuit 2, as the positive-side line current Ip flowing through the positive-side line 73p. The power conversion device 50 of Embodiment 4 is different from the power conversion devices 50 of Embodiment 1 and Embodiment 2 in that the rectifier circuit current Irc is the positive-side line current Ip. The following description will focus on differences from the power conversion devices 50 of Embodiment 1 and Embodiment 2.

A configuration of the controller 10 of Embodiment 4 is shown in FIG. 23. The controller 10 differs from the controller 10 shown in FIG. 2 in that the rectifier circuit current Irc is input to a negative-side input (minus input) of the subtractor 21 between the voltage feedback control unit 22 and the current feedback control unit 23. The subtractor 21 at the subsequent stage of the voltage feedback control unit 22 calculates a current deviation ΔI that is a deviation between the current command IL* for the control reactor 5 and a detection value of the rectifier circuit current Irc that is output from the rectifier circuit 2 and flows through the filter reactor 8. The current deviation ΔI is input to the current feedback control unit 23 that performs current feedback control. Although the detection value of the rectifier circuit current Irc does not completely match the detection value of the control reactor current IL of the control reactor 5, the rectifier circuit current Irc may be used as a substitute for the control reactor current IL because both the rectifier circuit current Irc and the control reactor current IL are of the positive-side line current Ip.

The power conversion device 50 of Embodiment 4 can prevent the breakage of the peripheral devices by reducing the outflow of the carrier ripple current, similarly to the power conversion devices 50 of Embodiment 1 and Embodiment 2. Furthermore, by reducing the distortion of the power supply current Ips, component losses can be reduced, and a component with a small current rating can be applied. In the power conversion device 50 of Embodiment 4, the LC filter 30 including the filter reactor 8 and the filter capacitor 9 is disposed between the AC input terminals 55r, 55s, and 55t, and the converter 31, and the filter reactor 8 is disposed closer to the AC input terminals 55r, 55s, and 55t than the filter capacitor 9. Therefore, it is possible to reduce the carrier ripple current and to reduce the outflow of the carrier ripple current to the power supply.

In addition, the power conversion device 50 according to Embodiment 4 observes the power supply side relative to the LC filter 30, and thus the power supply current Ips of the three-phase AC power supply 1 can be in a rectangular wave, that is, a rectangular wave current. Since the three-phase AC power supply 1 outputs three-phase AC currents, the power supply currents Ips of the respective phases are shifted by 120 degrees. Therefore, the power conversion device 50 according to Embodiment 4 can make the power supply current Ips closer to a rectangular wave current of 120-degree conduction than the power conversion devices 50 according to Embodiment 1 and Embodiment 2. In the power conversion device 50 of Embodiment 4, the converter 31 is controlled on the basis of the output voltage Vo and the rectifier circuit current Irc, and therefore, the current of the control reactor 5, that is, the control reactor current IL is distorted unless a special measure is taken. However, if the parameters of the LC filter 30, that is, the filter inductance Lf of the filter reactor 8 and the filter capacitance Cf of the filter capacitor 9 are set appropriately, the waveform distortion in the current of the control reactor 5, that is, in the control reactor current IL, can be reduced.

### Embodiment 5

FIG. 24 is a diagram showing a configuration of a refrigeration cycle apparatus according to Embodiment 5. FIG. 25 is a diagram showing a configuration of a refrigerant circuit of FIG. 24, and FIG. 26 is a diagram showing a configuration of an inverter of FIG. 24. In Embodiment 5, a refrigeration cycle apparatus 120 in which the power conversion device 50 including the converter 31, the LC filter 30, and the controller 10 according to Embodiment 1 to Embodiment 4 is mounted will be described.

The refrigeration cycle apparatus 120 includes a refrigerant circuit 110 that constitutes a refrigeration cycle in which a refrigerant circulates while changing in repeated processes of “compression”, “condensation”, “expansion”, and “evaporation”. Examples of the refrigeration cycle apparatus 120 include an air conditioner and a refrigeration device. In the following description, an air conditioner as the refrigeration cycle apparatus 120 will be described as an example.

The power conversion device 50 of Embodiment 5 shown in FIG. 24 is a power conversion device in which an inverter 32 is added to the power conversion device 50 of Embodiment 1 to Embodiment 4. In the power conversion device 50 of Embodiment 5 shown in FIG. 24, the DC output terminal 64p of the converter 31 and a DC input terminal 65p of the inverter 32 are connected by the positive-side power line 74p, and the DC output terminal 64n of the converter 31 and a DC input terminal 65n of the inverter 32 are connected by the negative-side power line 74n. In FIG. 24, the smoothing capacitor 6 connected between the positive-side power line 74p and the negative-side power line 74n and the voltage sensor 11 for detecting the output voltage Vo of the smoothing capacitor 6 are omitted. Further, in FIG. 24, the LC filter 30 disposed between the AC input terminals 55r, 55s, and 55t, and the converter 31 and including the filter reactor 8 and the filter capacitor 9 is omitted. The power conversion device 50 of Embodiment 5 shown in FIG. 24 is for an example of supplying three-phase AC power to a motor 51 being an AC motor.

The inverter 32 is a bridge inverter circuit including, for example, six switching elements 3a to 3f. The switching elements 3a and 3b connected in series are an arm of a u-phase of the three-phase AC, the switching elements 3c and 3d connected in series are an arm of a v-phase of the three-phase AC, and the switching elements 3e and 3f connected in series are an arm of a w-phase of the three-phase AC. An AC output terminal 66u is connected to the connection point of the switching elements 3a and 3b, an AC output terminal 66v is connected to the connection point of the switching elements 3c and 3d, and an AC output terminal 66w is connected to the connection point of the switching elements 3e and 3f. The collectors of the switching elements 3a, 3c, and 3e are connected to the positive-side DC input terminal 65p, and the emitters of the switching elements 3b, 3d, and 3f are connected to the negative-side DC input terminals 65n. The inverter 32 outputs three-phase AC power from the AC terminals 66u, 66v, and 66w through output terminals 56a, 56b, and 56c of the power conversion device 50. Input terminals 67a, 67b, and 67c of the refrigerant circuit 110 are connected to the output terminals 56a, 56b, and 56c of the power conversion device 50 by power lines 72u, 72v, and 72w. Note that the reference signs for the power lines connecting the AC output terminals 66u, 66v, and 66w of the inverter 32 and the output terminals 56a, 56b, and 56c of the power conversion device 50 are also denoted by 72u, 72v, and 72w. The reference signs for the power lines connected to the input terminals 67a, 67b, and 67c of the refrigerant circuit 110 are collectively denoted by a reference numeral 72, and 72u, 72v, and 72w are used for distinction.

A control signal s1a is input to the gate of the switching element 3a via a control terminal 59a, and a control signal s1b is input to the gate of the switching elements 3b via a control terminal 59b. Similarly, a control signal s1c is input to the gate of the switching element 3c via a control terminal 59c, and a control signal s1d is input to the gate of the switching device 3d via a control terminal 59d. A control signal s1e is input to the gate of the switching elements 3e via a control terminals 59e, and a control signal s1f is input to the gate of the switching elements 3f via a control terminal 59f. A reference numeral 59 is collectively used for the control terminals of the inverter 32, and 59a to 59f are used for distinction. The reference signs for the control signals input to the inverter 32 are collectively referred to as sig1b, and are referred to as s1a to s1f for distinction.

The control terminal 58 of the converter 31 receives a control signal sig1a output from a drive circuit 25a on the basis of the gate signal command G* output from the controller 10. The control terminal 59 of the inverter 32 receives a control signal sig1b output from a drive circuit 25b on the basis of a gate signal command Gi* output from the controller 10. The drive circuit 25a and the control signal sig1a are the drive circuit 25 and the control signal sig1 of the power conversion device 50 of Embodiment 1 to Embodiment 4. The control signal sig1b is a signal for controlling the ON state and the OFF state of the switching elements 3a to 3f by, for example, PWM control. The drive circuit 25b outputs the control signal sig1b whose voltage value is changed on the basis of the gate signal command Gi* output from the controller 10. The gate signal command Gi* is generated for each of the switching elements 3a to 3f. As the gate signal command Gi*, a gate signal command for performing normal PWM control can be used.

An air conditioner, which is an example of a refrigeration cycle apparatus 120, is connected by a refrigerant pipe 108 in the order of a compressor 101, a four-way valve 102, an outdoor heat exchanger 103, an expansion device 104, an indoor heat exchanger 105, the four-way valve 102, and the compressor 101 to form the refrigeration cycle, that is, the refrigerant circuit 110. That is, in the refrigerant circuit 110, the compressor 101, a condenser (the outdoor heat exchanger 103 or the indoor heat exchanger 105), the expansion device 104, and an evaporator (the indoor heat exchanger 105 or the outdoor heat exchanger 103) are connected in a loop by the refrigerant pipe. In the refrigerant circuit 110, the indoor heat exchanger 105 is an indoor part 107, and the compressor 101, the four-way valve 102, the outdoor heat exchanger 103, and the expansion device 104 are an outdoor part 106. An indoor unit of the air conditioner includes the indoor heat exchanger 105 of the indoor part 107. An outdoor unit of the air conditioner includes the power conversion device 50, and the compressor 101, the four-way valve 102, the outdoor heat exchanger 103, and the expansion device 104 of the outdoor part 106. The compressor 101 includes the motor 51 and compression components 101a. The motor 51 is supplied with electric power from the power conversion device 50 and is rotationally driven. The power conversion device 50 supplies electric power to the motor 51 to rotationally drive the motor 51. The motor 51 is connected to the compression components 101a, and the motor 51 and the compression components 101a constitute the compressor 101 that compresses the refrigerant.

Next, the operation of the air conditioner will be described by taking a cooling operation as an example. Note that, when the cooling operation is performed, it is assumed that the four-way valve 102 switches the flow path in advance such that the refrigerant discharged from the compressor 101 is directed to the outdoor heat exchanger 103 and the refrigerant flowing out from the indoor heat exchanger 105 is directed to the compressor 101.

The motor 51 of the compressor 101 is rotationally driven by the power conversion device 50, whereby the compression components 101a of the compressor 101 connected to the motor 51 compress the refrigerant, and the compressor 101 discharge a high-temperature and high-pressure refrigerant. The high-temperature and high-pressure refrigerant discharged from the compressor 101 flows into the outdoor heat exchanger 103 via the four-way valve 102, and exchanges heat with the outside air in the outdoor heat exchanger 103 to radiate heat. The refrigerant flowing out of the outdoor heat exchanger 103 is expanded and decompressed by the expansion device 104 to become a low-temperature and low-pressure gas-liquid two-phase refrigerant, and flows into the indoor heat exchanger 105. The refrigerant that has flowed into the indoor heat exchanger 105 exchanges heat with the air in the space to be air-conditioned, evaporates, becomes a low-temperature and low-pressure gas refrigerant, and flows out of the indoor heat exchanger 105. The gas refrigerant flowing out of the indoor heat exchanger 105 is sucked into the compressor 101 via the four-way valve 102 and compressed again. The above operation is repeated. When the air conditioner performs the cooling operation, the outdoor heat exchanger 103 functions as the condenser, and the indoor heat exchanger 105 functions as the evaporator. When the air conditioner performs the heating operation, the outdoor heat exchanger 103 functions as the evaporator and the indoor heat exchanger 105 functions as the condenser, which is the reverse of the cooling operation.

Note that, although FIG. 24 shows an example in which the power conversion device 50 in which the inverter 32 is added to the power conversion device 50 of Embodiment 1 to Embodiment 4 is applied to the power conversion device that supplies power to the compressor 101 of the air conditioner as an example of the refrigeration cycle apparatus 120, this is not a limitation. It is needless to say that the refrigeration cycle apparatus 120 can be applied to a heat pump device, a refrigeration device, and other refrigeration cycle apparatuses in general, in addition to the air conditioner.

As described above, the refrigeration cycle apparatus 120 of Embodiment 5 includes the refrigerant circuit 110 in which the compressor 101, the condenser (the outdoor heat exchanger 103 or the indoor heat exchanger 105), the expansion device 104, and the evaporator (the indoor heat exchanger 105 or the outdoor heat exchanger 103) are connected in a loop by the refrigerant pipe 108, and the power conversion device 50 that drive the compressor 101 by supplying electric power to the compressor. The power conversion device 50 includes the rectifier circuit 2 that converts the input voltages (interphase voltage Vac) of the three-phase AC input from the AC input terminals 55r, 55s, and 55t into the DC voltage, the converter 31 that outputs the output voltage Vo set to the set voltage value from the DC voltage output from the rectifier circuit 2, the smoothing capacitor 6 connected between the positive-side converter output terminal (DC output terminal 64p) and the negative-side converter output terminal (DC output terminal 64n) of the converter 31 from which the output voltage Vo is output, the LC filter 30 including the filter reactor 8 and the filter capacitor 9 and disposed between the AC input terminals 55r, 55s, and 55t, and the converter 31, and the controller 10 that controls the converter 31. The power conversion device 50 further includes the inverter 32 that converts the DC output voltage Vo output from the converter 31 into the AC voltage and is controlled by the controller 10. The filter reactor 8 is disposed closer to the AC input terminals 55r, 55s, and 55t than the filter capacitor 9. In the refrigeration cycle apparatus 120 of Embodiment 5, with this configuration, the LC filter 30 including the filter reactor 8 and the filter capacitor 9 is disposed between the AC input terminals 55r, 55s, and 55t, and the converter 31, and the filter reactor 8 is disposed closer to the AC input terminals 55r, 55s, and 55t than the filter capacitor 9 in the power conversion device 50. Therefore, the carrier ripple current can be reduced, and the outflow of the carrier ripple current to the power supply can be reduced.

Note that, although various exemplary embodiments and examples are described in the present disclosure, various features, aspects, and functions described in one or more embodiments are not inherent in a particular embodiment and can be applicable alone or in their various combinations to each embodiment. Accordingly, countless variations that are not illustrated are envisaged within the scope of the art disclosed in the disclosure. For example, the case where at least one component is modified, added or omitted, and the case where at least one component is extracted and combined with a component in another embodiment are included.

Although the preferred embodiments and the like have been described in detail above, the above-described embodiments and the like is not a limitation, and various modifications and substitutions can be made to the above-described embodiments and the like without departing from the scope described in the claims.

Hereinafter, various aspects of the present disclosure will be collectively described as supplementary notes.

### Supplementary Note 1

The power conversion device includes the rectifier circuit to convert an input voltage of the three-phase AC input from the AC input terminals into a DC voltage, the converter to output an output voltage set to a set voltage value from the DC voltage output from the rectifier circuit, the smoothing capacitor connected between the positive-side converter output terminal and the negative-side converter output terminal of the converter from which the output voltage is output, the LC filter disposed between the AC input terminals and the converter and including the filter reactor and the filter capacitor, the controller to control the converter. The filter reactor is disposed closer to the AC input terminals than the filter capacitor.

### Supplementary Note 2

The power conversion device according to Supplementary Note 1, wherein the filter reactor is connected between the positive-side rectifier circuit output terminal of the rectifier circuit and one end of the filter capacitor connected to the positive-side converter input terminal of the converter.

### Supplementary Note 3

The power conversion device according to Supplementary Note 1, wherein the filter reactor is connected between the AC input terminal and a rectifier circuit input terminal of the rectifier circuit.

### Supplementary Note 4

The power conversion device according to Supplementary Note 3, wherein the filter reactor constitutes the common mode choke coil.

### Supplementary Note 5

The power conversion device according to Supplementary Note 1 or 2, wherein, when Vac is a voltage between two phases of the three-phase AC, input from the AC input terminals, and P is power of the three-phase AC input from the AC input terminals, the electrostatic capacitance Cf of the filter capacitor in farad (F) satisfies Cf≤P/Vac²×0.001, and is equal to or greater than the lower limit electrostatic capacitance.

### Supplementary Note 6

The power conversion device according to Supplementary Note 3 or 4, wherein, when Vac is a voltage between two phases of the three-phase AC, input from the AC input terminals, and P is power of the three-phase AC input from the AC input terminals, the electrostatic capacitance Cf of the filter capacitor in farad (F) satisfies Cf≤P/Vac²×0.001, and is equal to or greater than the lower limit electrostatic capacitance.

### Supplementary Note 7

The power conversion device according to any one of Supplementary Notes 1, 2, and 5, wherein the converter includes the switching element that is controlled with PWM by the control signal generated on the basis of the carrier wave and the on-duty command, and the resonant frequency of the LC filter is set to be equal to or higher than the predetermined lower limit frequency and equal to or lower than half of a frequency of the carrier wave.

### Supplementary Note 8

The power conversion device according to any one of Supplementary Notes 3, 4, and 6, wherein the converter includes the switching element that is controlled with PWM by the control signal generated on the basis of the carrier wave and the on-duty command, and the resonant frequency of the LC filter is set to be equal to or higher than the predetermined lower limit frequency and equal to or lower than half of a frequency of the carrier wave.

### Supplementary Note 9

The power conversion device according to Supplementary Note 7, wherein the lower limit frequency is a frequency 18 times a frequency of the three-phase AC.

### Supplementary Note 10

The power conversion device according to Supplementary Note 8, wherein the lower limit frequency is a frequency 18 times a frequency of the three-phase AC.

### Supplementary Note 11

The power conversion device according to Supplementary Note 7 or 9, wherein the controller includes the current feedback control unit to generate the on-duty command for controlling a current flowing through the filter reactor to be within the predetermined current setting range.

### Supplementary Note 12

The power conversion device according to any one of Supplementary Notes 7 to 10, wherein the converter includes the control reactor, and the controller includes the current feedback control unit that generates the on-duty command for controlling a current flowing through the control reactor to be within the predetermined current setting range.

### Supplementary Note 13

The power conversion device according to Supplementary Note 11 or 12, wherein the current setting range is set such that an input current of the three-phase AC is to be a rectangular wave current.

### Supplementary Note 14

The power conversion device according to any one of Supplementary Notes 1 to 13, wherein the converter is one of the step-down converter, the step-up converter, and the step-up/step-down converter.

### Supplementary Note 15

The power conversion device according to any one of supplementary Notes 1 to 14, further includes the inverter that converts the output voltage of the DC output from the converter into an AC voltage, wherein the controller controls the inverter.

### Supplementary Note 16

A refrigeration cycle apparatus includes the refrigerant circuit in which the compressor, the condenser, the expansion device, and the evaporator are connected in a loop by the refrigerant pipe, and the power conversion device according to Supplementary Note 15 that drives the compressor by supplying electric power to the compressor.

What is claimed is:

1. A power conversion device comprising:
a rectifier circuit to convert an input voltage of a three-phase AC input from AC input terminals into a DC voltage;
a converter to output an output voltage set to a set voltage value from the DC voltage output from the rectifier circuit;
a smoothing capacitor connected between a positive-side converter output terminal and a negative-side converter output terminal of the converter from which the output voltage is output;
an LC filter disposed between the AC input terminals and the converter and including a filter reactor and a filter capacitor; and
a controller to control the converter, wherein
the filter reactor is disposed closer to the AC input terminals than the filter capacitor.

2. The power conversion device according to claim 1, wherein the filter reactor is connected between a positive-side rectifier circuit output terminal of the rectifier circuit and one end of the filter capacitor connected to a positive-side converter input terminal of the converter.

3. The power conversion device according to claim 1, wherein the filter reactor is connected between the AC input terminal and a rectifier circuit input terminal of the rectifier circuit.

4. The power conversion device according to claim 3, wherein the filter reactor constitutes a common mode choke coil.

5. The power conversion device according to claim 1, wherein, when Vac is a voltage between two phases of the three-phase AC, input from the AC input terminals, and P is power of the three-phase AC input from the AC input terminals, an electrostatic capacitance Cf of the filter capacitor in farad (F) satisfies Cf≤P/Vac²×0.001, and is equal to or greater than a lower limit electrostatic capacitance.

6. The power conversion device according to claim 2, wherein, when Vac is a voltage between two phases of the three-phase AC, input from the AC input terminals, and P is power of the three-phase AC input from the AC input terminals, an electrostatic capacitance Cf of the filter capacitor in farad (F) satisfies Cf≤P/Vac²×0.001, and is equal to or greater than a lower limit electrostatic capacitance.

7. The power conversion device according to claim 3, wherein, when Vac is a voltage between two phases of the three-phase AC, input from the AC input terminals, and P is power of the three-phase AC input from the AC input terminals, an electrostatic capacitance Cf of the filter capacitor in farad (F) satisfies Cf≤P/Vac²×0.001, and is equal to or greater than a lower limit electrostatic capacitance.

8. The power conversion device according to claim 4, wherein, when Vac is a voltage between two phases of the three-phase AC input from the AC input terminals, and P is power of the three-phase AC input from the AC input terminals, an electrostatic capacitance Cf of the filter capacitor in farad (F) satisfies Cf≤P/Vac²×0.001, and is equal to or greater than a lower limit electrostatic capacitance.

9. The power conversion device according to claim 1, wherein the converter includes a switching element that is controlled with PWM by a control signal generated on a basis of a carrier wave and an on-duty command, and a resonant frequency of the LC filter is set to be equal to or higher than a predetermined lower limit frequency and equal to or lower than half of a frequency of the carrier wave.

10. The power conversion device according to claim 2, wherein the converter includes a switching element that is controlled with PWM by a control signal generated on a basis of a carrier wave and an on-duty command, and a resonant frequency of the LC filter is set to be equal to or higher than a predetermined lower limit frequency and equal to or lower than half of a frequency of the carrier wave.

11. The power conversion device according to claim 3, wherein the converter includes a switching element that is controlled with PWM by a control signal generated on a basis of a carrier wave and an on-duty command, and a resonant frequency of the LC filter is set to be equal to or higher than a predetermined lower limit frequency and equal to or lower than half of a frequency of the carrier wave.

12. The power conversion device according to claim 4, wherein the converter includes a switching element that is controlled with PWM by a control signal generated on a basis of a carrier wave and an on-duty command, and a resonant frequency of the LC filter is set to be equal to or higher than a predetermined lower limit frequency and equal to or lower than half of a frequency of the carrier wave.

13. The power conversion device according to claim 9, wherein the lower limit frequency is a frequency 18 times a frequency of the three-phase AC.

14. The power conversion device according to claim 11, wherein the lower limit frequency is a frequency 18 times a frequency of the three-phase AC.

15. The power conversion device according to claim 9, wherein the controller includes a current feedback control unit to generate the on-duty command for controlling a current flowing through the filter reactor to be within a predetermined current setting range.

16. The power conversion device according to claim 9, wherein the converter includes a control reactor, and the controller includes a current feedback control unit that generates the on-duty command for controlling a current flowing through the control reactor to be within a predetermined current setting range.

17. The power conversion device according to claim 15, wherein the current setting range is set such that an input current of the three-phase AC is to be a rectangular wave current.

18. The power conversion device according to claim 1, wherein the converter is one of a step-down converter, a step-up converter, and a step-up/step-down converter.

19. The power conversion device according to claim 1, further comprising:
an inverter that converts the output voltage of a DC output from the converter into an AC voltage, wherein the controller controls the inverter.

20. A refrigeration cycle apparatus comprising:
a refrigerant circuit in which a compressor, a condenser, an expansion device, and an evaporator are connected in a loop by a refrigerant pipe; and
the power conversion device according to claim 19 that drives the compressor by supplying electric power to the compressor.
